(19) United States
(12) Patent Application Publication
(10) Pub. No.: US 2026/0152204 A1
(43) Pub. Date: Jun. 4, 2026

(54) VEHICLE

(71) Applicant: TOYOTA JIDOSHA KABUSHIKI KAISHA, Toyota-shi (JP)

(72) Inventors: Arata TAKADA, Toyota-shi (JP); Tsutomu HATTORI, Toyota-shi (JP); Shogo KONISHI, Nagoya-shi (JP); Takashi NISHIDA, Chiryu-shi (JP)

(73) Assignee: TOYOTA JIDOSHA KABUSHIKI KAISHA, Toyota-shi (JP)

(21) Appl. No.: 19/341,226

(22) Filed: Sep. 26, 2025

(30) Foreign Application Priority Data
Oct. 22, 2024 (JP) 2024-185959

(51) Int. Cl. B60W 50/14; B60Q 9/00

(52) U.S. Cl. CPC B60W 50/14; B60Q 9/00; B60W 2050/146; B60W 2552/10; B60W 2554/00; B60W 2710/20; B60W 2720/106

(57) ABSTRACT

A vehicle, including: an assistance section that, in a case in which the vehicle is in a driving assistance mode, is configured to perform assistance processing that assists at least one of acceleration/deceleration of the vehicle or steering of the vehicle, based on a recognition result of an object by an object recognition section; and a display control section that, in a case in which the vehicle is in a manual driving mode in which the assistance section does not perform the assistance processing, is configured to cause display of, at a display, an object that is recognized by the object recognition section.

### CROSS-REFERENCE TO RELATED APPLICATION

This application claims priority under 35 USC 119 from Japanese Patent Application No. 2024-185959, filed on Oct. 22, 2024, the disclosure of which is incorporated by reference herein.

### BACKGROUND

### Technical Field

The present disclosure relates to a vehicle.

### Related Art

Japanese Patent Application Laid-Open (JP-A) No. 2022-41288 describes causing display of an object, such as another vehicle or the like, at a display, during automatic driving (assistance processing) in which some or all of the operations, such as an accelerator, a brake, a direction indicator, and steering, are automatically performed.

In the technology described in Japanese Patent Application Laid-Open (JP-A) No. 2022-41288, when assistance processing is not being executed (in a case in which the vehicle is in the manual driving mode), since an object such as another vehicle is not displayed at the display, there is a possibility of causing anxiety to the occupant.

### SUMMARY

The present disclosure provides a vehicle that enables an occupant to recognize that an object has been recognized by the vehicle, even in a case in which the vehicle is in a manual driving mode.

A first aspect is a vehicle including: an assistance section that, in a case in which the vehicle is in a driving assistance mode, is configured to perform assistance processing that assists at least one of acceleration/deceleration of the vehicle or steering of the vehicle, based on a recognition result of an object by an object recognition section; and a display control section that, in a case in which the vehicle is in a manual driving mode in which the assistance section does not perform the assistance processing, is configured to cause display of, at a display, an object that is recognized by the object recognition section.

In the first aspect, in a case in which the vehicle is in the driving assistance mode, assistance processing that assists at least one of acceleration/deceleration of the vehicle or steering of the vehicle is performed, and in a case in which the vehicle is in the manual driving mode, assistance processing is not performed. On the other hand, in a case in which the vehicle is in the manual driving mode, the display control section causes display of, at the display, an object that is recognized by the object recognition section. This may enable an occupant to recognize that an object has been recognized by the vehicle in a case in which the vehicle is in the manual driving mode, thereby enabling the occupant to have a sense of security.

In a second aspect, in the first aspect, in a case in which the vehicle is in the manual driving mode, the object that is displayed at the display may be a peripheral object that is in a lane other than a host vehicle lane in which the vehicle is traveling.

In the second aspect, since a peripheral object that is in a lane other than the host vehicle lane is displayed at the display, the occupant may recognize that the peripheral object has been recognized by the vehicle in the manual driving mode.

A third aspect is a vehicle including: an assistance section that, in a case in which the vehicle is in a driving assistance mode, is configured to perform assistance processing that assists at least one of acceleration/deceleration of the vehicle or steering of the vehicle, based on a recognition result of an object by an object recognition section; and a display control section that is configured to: switch a screen that is displayed at a display to a peripheral monitoring screen or another screen, in accordance with an input instruction, and in a state of causing display of the peripheral monitoring screen at the display, cause display of, at the display, an object that is recognized by the object recognition section even in a case in which the vehicle is in a manual driving mode in which the assistance section does not perform the assistance processing.

Similarly to in the first aspect, in the third aspect, in a case in which the vehicle is in the driving assistance mode, assistance processing that assists at least one of acceleration/deceleration of the vehicle or steering of the vehicle is performed, and in a case in which the vehicle is in the manual driving mode, assistance processing is not performed. Further, in the third aspect, the screen that is displayed at the display can be switched to a peripheral monitoring screen or another screen, and in a state in which the peripheral monitoring screen is displayed at the display, an object that is recognized by the object recognition section is displayed at the display even in a case in which the vehicle is in the manual driving mode. This may enable the object that is recognized by the object recognition section to be displayed at the display, and enables the occupant to recognize that the object has been recognized by the vehicle, simply by switching the screen that is displayed at the display to the peripheral monitoring screen, without performing an operation of switching to the driving assistance mode and activating the assistance processing, in a case in which the vehicle is in the manual driving mode.

In a fourth aspect, in the third aspect, wherein, in a state in which the other screen is displayed at the display, the display control section may cause display of, at the display, information including an operation state of the assistance processing, and may not cause display of, at the display, the object that is recognized by the object recognition section.

In the fourth aspect, in a case in which the vehicle is in the manual driving mode, switching the screen that is displayed at the display to the other screen enables the occupant to understand the operating state of the assistance processing, while not displaying the object enables complexity of display to be reduced.

According to the above-described aspects, the vehicle of the present disclosure may enable an occupant to recognize that an object has been recognized by the vehicle even in a case in which the vehicle is in a manual driving mode.

### BRIEF DESCRIPTION OF THE DRAWINGS

An Exemplary embodiment will be described in detail based on the following figures, wherein:

FIG. 1 is a block diagram schematically illustrating a configuration of an in-vehicle system according to an exemplary embodiment;

FIG. 2 is a flowchart illustrating an example of screen display processing;

FIG. 3 is an image diagram illustrating an example of a peripheral monitoring screen that is displayed at a display in a case in which a vehicle is in a driving assistance mode;

FIG. 4 is an image diagram illustrating an example of a peripheral monitoring screen that is displayed at a display in a case in which a vehicle is in a manual driving mode;

FIG. 5 is an image diagram illustrating an example of a meter screen that is displayed at a display in a case in which a vehicle is in a manual driving mode; and

FIG. 6 is an image diagram illustrating an example of a travel mode display screen that is displayed at a display in a case in which a vehicle is in a manual driving mode.

### DETAILED DESCRIPTION

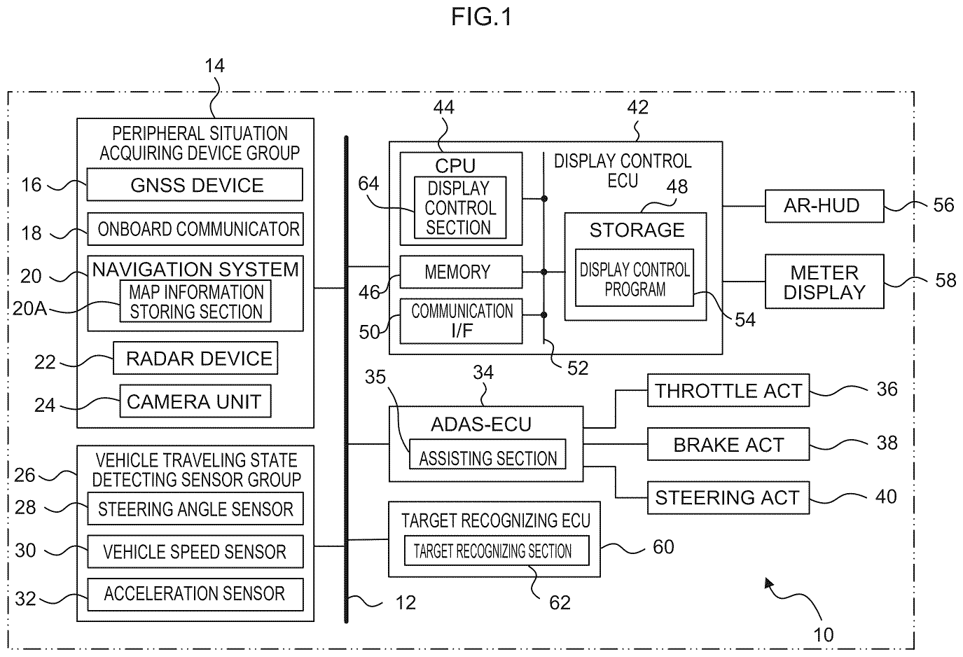

Explanation follows regarding an exemplary embodiment of the present disclosure in detail, with reference to the drawings. As illustrated in FIG. 1, an in-vehicle system 10 according to the present exemplary embodiment is installed at a vehicle 11, and includes a communication bus 12. A peripheral situation acquisition device group 14, a vehicle travel state detection sensor group 26, an object recognition electronic control unit (ECU) 60, an advanced driver-assistance system (ADAS)-ECU 34, and a display control ECU 42 are each connected to the communication bus 12. Note that FIG. 1 shows only a portion of the in-vehicle system 10. Further, in the following, the vehicle 11, at which the in-vehicle system 10 is installed, is referred to as a host vehicle 11. The host vehicle 11 is an example of a vehicle according to the present disclosure.

The peripheral situation acquisition device group 14 includes a global navigation satellite system (GNSS) device 16, an in-vehicle communication device 18, a navigation system 20, a radar device 22, a camera unit 24, and the like, as devices that acquire information indicating what kind of situation the peripheral environment of the host vehicle 11 is in.

The GNSS device 16 receives GNSS signals from plural GNSS satellites, and measures the position of the host vehicle 11. The in-vehicle communication device 18 performs at least one of vehicle-to-vehicle communication with another vehicle or road-to-vehicle communication with a roadside device. The navigation system 20 includes a map information storage section 20A that stores map information, and performs processing for displaying the position of the host vehicle 11 on a map, or determining and guiding a route to a destination, based on positional information obtained from the GNSS device 16 and map information stored in the map information storage section 20A.

The radar device 22 detects that there is an object, such as another vehicle or a pedestrian in the vicinity of the host vehicle 11, as point cloud information, and acquires a relative position and a relative speed of the host vehicle 11 with respect to the detected object. Further, the radar device 22 excludes roadside objects and the like, such as noise and guard rails, from monitoring targets based on changes in a relative position and a relative speed with respect to individual objects, and outputs information such as a relative position and a relative speed with respect to monitoring targets (objects) such as other vehicles, pedestrians, and the like. The camera unit 24 captures images of the vicinity of the host vehicle 11 with plural cameras, and outputs the captured images.

The vehicle travel state detection sensor group 26 includes, as plural sensors that acquire the travel state of the host vehicle 11, a steering angle sensor 28 that detects a steering angle of the host vehicle 11, a vehicle speed sensor 30 that detects a travel speed of the host vehicle 11, and an acceleration sensor 32 that detects acceleration applied to the host vehicle 11.

Although not illustrated in the drawings, the object recognition ECU 60 includes a central processing unit (CPU) and memory such as read only memory (ROM) or random access memory (RAM), and storage such as a hard disk drive (HDD) or a solid state drive (SSD). A predetermined program for causing the CPU of the object recognition ECU 60 to function as an object recognition section 62 is stored in the storage. The object recognition section 62 recognizes a boundary line of a lane (host vehicle lane) in which the host vehicle 11 is traveling, from an image of ahead of the host vehicle 11 which is captured by the camera unit 24. Further, regardless of whether a driving mode of the host vehicle 11 is a manual driving mode or a driving assistance mode, the objection recognition section 62 recognizes that there is an object that is in the vicinity of the host vehicle 11 (such as a preceding vehicle traveling in the host vehicle lane or a vehicle traveling in an adjacent lane) from in an image captured by the camera unit 24, recognizes a type of object (such as a standard-sized vehicle or a large-sized vehicle), and detects and outputs a distance between the host vehicle 11 and the object. Alternatively, the object recognition section 62 detects and outputs a distance calculated by combining a depth to the object by the radar device 22 and an orientation of the object detected by the cameras.

The ADAS-ECU 34 is connected to a throttle ACT 36 that changes a throttle opening degree of the host vehicle 11, a brake ACT 38 that changes a braking force generated by a braking device of the host vehicle 11, and a steering ACT 40 that changes a steering amount by a steering device of the host vehicle 11, respectively.

Although not illustrated in the drawings, the ADAS-ECU 34 includes a CPU, memory such as ROM or RAM, storage such as an HDD or an SSD, and a communication interface (I/F). A predetermined program for causing the CPU of the ADAS-ECU 34 to function as an assistance section 35 is stored in the storage. The assistance section 35 controls the throttle ACT 36, the brake ACT 38, and the steering ACT 40 based on information obtained from the peripheral situation acquisition device group 14 and the vehicle travel state detection sensor group 26, a recognition result of an object by the object recognition section 62, and the like, and performs assistance processing that assists at least one of acceleration/deceleration of the host vehicle 11 or steering of the host vehicle 11.

In the present exemplary embodiment, a driving assistance function realized by the above-described assistance processing is adaptive cruise control (ACC), that causes the host vehicle 11 to travel so as to follow a preceding vehicle traveling in the host vehicle lane, and lane keeping assist (LKA) that assists steering of the host vehicle 11 so as to travel along the center of the host vehicle lane. Although not illustrated in the drawings, in the in-vehicle system 10 according to the present exemplary embodiment, a first switch for turning on and off the ACC, and a second switch for turning on and off the LKA are respectively provided. In the present exemplary embodiment, when at least one of the ACC or the LKA is turned ON due to operation of at least one of the first switch or the second switch, the driving mode of the host vehicle 11 transitions from the manual driving mode to the driving assistance mode, and assistance processing is performed by the assistance section 35. Note that when both the ACC and the LKA are turned OFF, the driving mode of the host vehicle 11 transitions from the driving assistance mode to the manual driving mode.

The display control ECU 42 includes a CPU 44, memory 46 such as ROM or RAM, storage 48 such as an HDD or an SSD, and a communication I/F 50. The CPU 44, the memory 46, the storage 48, and the communication I/F 50 are communicably connected to each other via an internal bus 52. A display control program 54 is stored in the storage 48. The display control ECU 42 functions as a display control section 64 by the display control program 54 being read from the storage 48 and loaded in the memory 46, and the display control program 54 that is loaded in the memory 46 being executed by the CPU 44, and performs screen display processing, which is described below.

An augmented reality (AR)-head-up display (hereinafter referred to as AR-HUD) 56 and a meter display 58 are connected to the display control ECU 42. The AR-HUD 56 according to the present exemplary embodiment is a small HUD that uses a portion of the front visual field of an occupant of the host vehicle 11 as a display area (forms an image in the lower foreground) by reflection or the like on a windshield. Further, the meter display 58 is a display that is provided at an instrument panel of the host vehicle 11. The display control ECU 42 controls information display at the AR-HUD 56 and the meter display 58. Note that the AR-HUD 56 and the meter display 58 are examples of displays in the present disclosure.

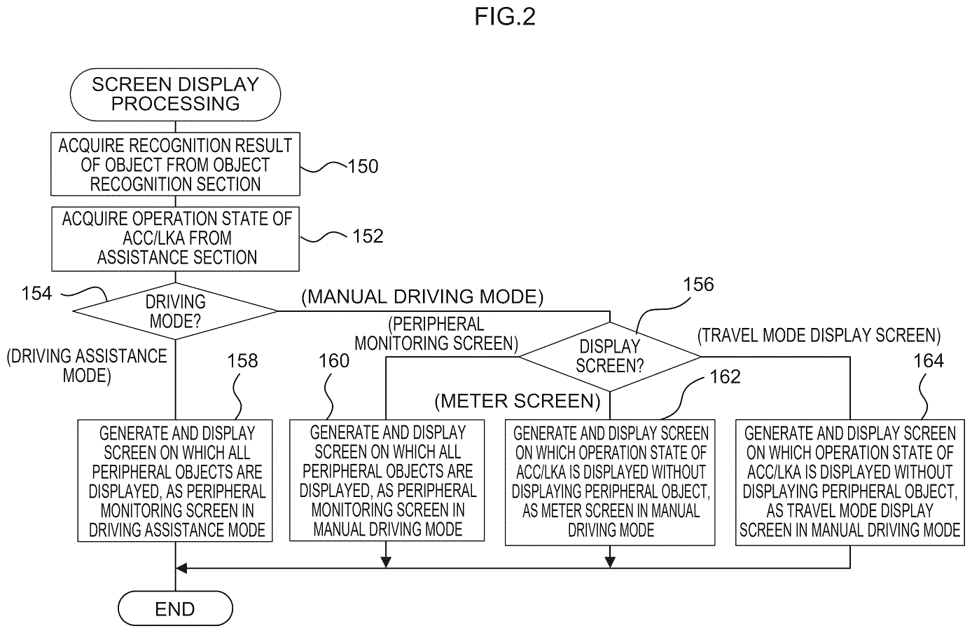

Explanation follows regarding screen display processing that is repeatedly executed by the display control ECU 42 (the display control section 64) while an ignition switch of the host vehicle 11 is ON, as an operation of the present exemplary embodiment, with reference to FIG. 2.

At step 150 of the screen display processing, the display control section 64 acquires the recognition result of an object from the object recognition section 62. The recognition result acquired here includes a recognition result of a vehicle (preceding object) which is traveling ahead of the host vehicle 11 and in the host vehicle lane, and a recognition result of a vehicle (peripheral object) which is traveling in a lane adjacent to the host vehicle lane. Further, at step 152, the display control section 64 acquires the operation states of the ACC and the LKA from the assistance section 35.

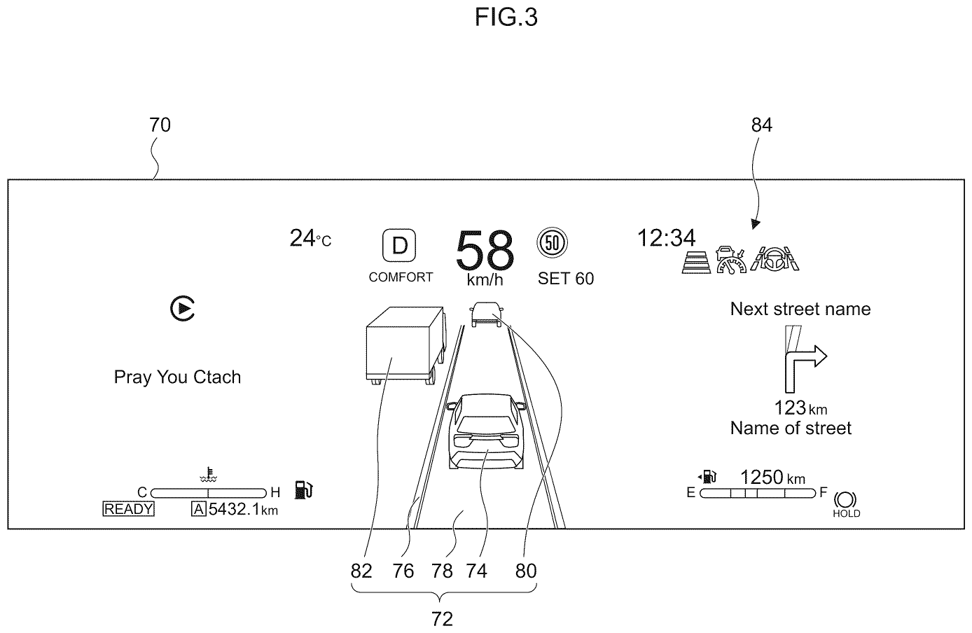

At step 154, the display control section 64 acquires the current driving mode of the host vehicle 11, and branches in accordance with the acquired current driving mode. In a case in which the current driving mode of the host vehicle 11 is the driving assistance mode, the processing transitions from step 154 to step 158. At step 158, as illustrated in FIG. 3, by way of example, the display control section 64 generates a screen on which all of the peripheral objects that are recognized by the object recognition section 62 are displayed, as a peripheral monitoring screen 70 in a case in which the driving mode of the host vehicle 11 is the driving assistance mode, and causes display of the peripheral monitoring screen 70 at the display (for example, at the meter display 58).

As illustrated in FIG. 3, in the peripheral monitoring screen 70, in a case in which the host vehicle 11 is in the driving assistance mode, a peripheral situation image 72 that indicates a peripheral situation of the host vehicle 11 is displayed at a central portion, in the left-right direction, of the peripheral monitoring screen 70. The peripheral situation image 72 in the peripheral monitoring screen 70 includes at least an icon 74 that represents the host vehicle 11, a boundary line 76 that represents a boundary of the host vehicle lane, and a strip-shaped image 78 in which a central portion of the host vehicle lane is filled in a strip shape with a constant width. Note that, in a case in which the driving mode is the driving assistance mode, the boundary line 76 and the strip-shaped image 78 are highlighted in a first predetermined color (for example, green) that is relatively conspicuous, thereby clearly indicating that the ACC or the like is in operation. Further, in a case in which there is a preceding object ahead of the host vehicle 11 (for example, a preceding vehicle that is to be followed by ACC), a preceding object image 80 is additionally displayed at the peripheral situation image 72 in the peripheral monitoring screen 70, and in a case in which a peripheral object is in an adjacent lane, a peripheral object image 82 is additionally displayed at the peripheral situation image 72 in the peripheral monitoring screen 70. Note that FIG. 3 illustrates a case in which the type of peripheral object represented by the peripheral object image 82 is a large-sized vehicle such as a truck or a bus. Further, in the peripheral monitoring screen 70, an icon group 84 that represents the operation states of the ACC and the LKA is displayed in the vicinity of the time display. In a case in which the driving mode is the driving assistance mode, the icon group 84 is also highlighted in the first predetermined color, thereby clearly indicating that the ACC or the like is in operation.

In a case in which the peripheral monitoring screen 70 illustrated in FIG. 3 is displayed at the display, the occupant can intuitively recognize that the ACC or the like is in operation based on the boundary line 76, the strip-shaped image 78, and the icon group 84 being highlighted in the first predetermined color. Further, by the preceding object image 80 and the peripheral object image 82 being displayed at the peripheral situation image 72 in the peripheral monitoring screen 70, the occupant can intuitively recognize that the objects corresponding to these images 80 and 82 are recognized by the host vehicle 11.

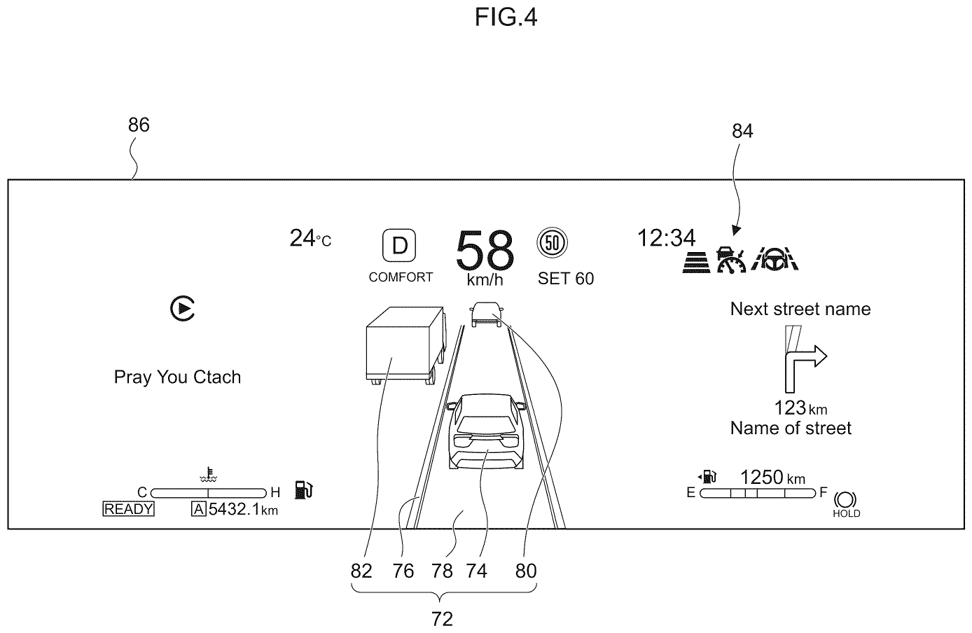

Further, in a case in which the current driving mode of the host vehicle 11 is the manual driving mode, the processing transitions from step 154 to step 156. In the present exemplary embodiment, in the manual driving mode, a screen to be displayed at the display can be selected from plural types of screens, and at step 156, the display control section 64 determines the screen that is instructed to be displayed at the display, and branches in accordance with the determination result. In a case in which the screen that is instructed to be displayed at the display is a peripheral monitoring screen, the processing transitions from step 156 to step 160. At step 160, as illustrated in FIG. 4, by way of example, the display control section 64 generates a screen on which all of the peripheral objects that are recognized by the object recognition section 62 are displayed, as a peripheral monitoring screen 86, in a case in which the driving mode of the host vehicle 11 is the manual driving mode, and causes display of the peripheral monitoring screen 86 at the display (for example, at the meter display 58).

As illustrated in FIG. 4, in the peripheral monitoring screen 86 in the manual driving mode, in the same manner as in the peripheral monitoring screen 70 in the driving assistance mode, the peripheral situation image 72 including at least the icon 74, the boundary line 76, and the strip-shaped image 78 is displayed at a central portion, in the left-right direction, of the peripheral monitoring screen 86. Note that in a case in which the driving mode is the manual driving mode, the boundary line 76 and the strip-shaped image 78 are displayed in a second predetermined color (for example, white), which is relatively inconspicuous, thereby clearly indicating that the ACC or the like is not in operation. Further, in a case in which there is a preceding object ahead of the host vehicle 11, the preceding object image 80 is additionally displayed at the peripheral situation image 72, and in a case in which there is a peripheral object in an adjacent lane, the peripheral object image 82 is additionally displayed at the peripheral situation image 72. Note that FIG. 4, similarly to FIG. 3, illustrates a case in which the type of peripheral object represented by the peripheral object image 82 is a large-sized vehicle such as a truck or a bus. Furthermore, in the peripheral monitoring screen 86, the icon group 84 representing the operation states of the ACC and the LKA is displayed in the vicinity of the time display. In a case in which the driving mode is the manual driving mode, the icon group 84 is also displayed in the second predetermined color, thereby clearly indicating that the ACC or the like is not in operation.

In a case in which the peripheral monitoring screen 86 illustrated in FIG. 4 is displayed at the display, the occupant can intuitively recognize that the ACC or the like is not in operation based on the boundary line 76, the strip-shaped image 78, and the icon group 84 being displayed in the second predetermined color. Further, by the preceding object image 80 and the peripheral object image 82 being displayed at the peripheral situation image 72 in the peripheral monitoring screen 86, the occupant can intuitively recognize that the objects corresponding to these images 80 and 82 are recognized by the host vehicle 11. Furthermore, in a case in which a meter screen 88 or a travel mode display screen 94, which are described below, is displayed at the display in the manual driving mode of the host vehicle 11, the object that is recognized by the object recognition section 62 can be displayed at the display simply by switching the screen displayed at the display to the periphery monitoring screen 86, without performing an operation of switching to the driving assistance mode.

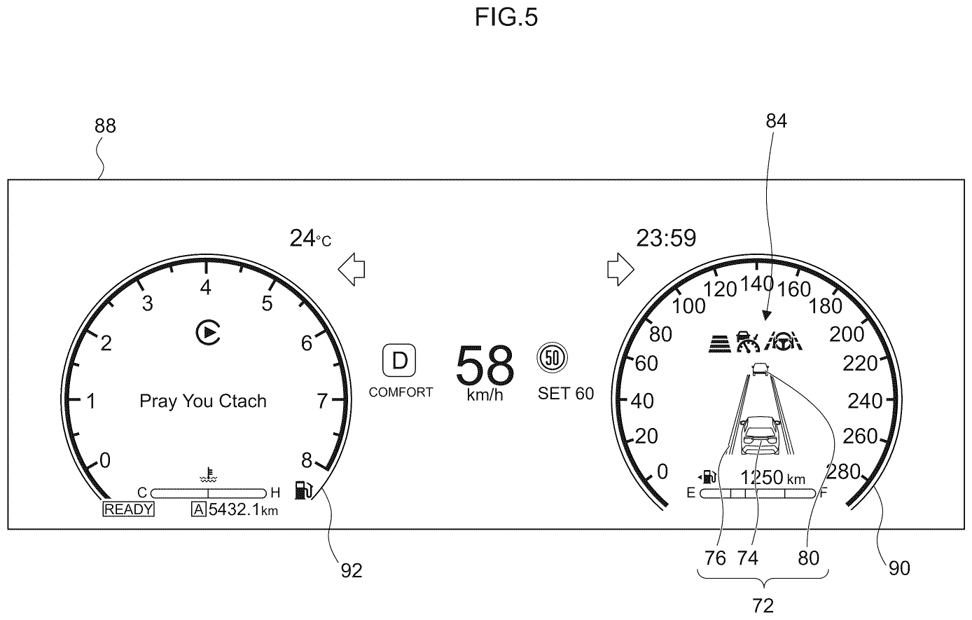

Further, in a case in which the screen that is instructed to be displayed at the display is the meter screen 88, the processing transitions from step 156 to step 162. At step 162, as illustrated in FIG. 5, by way of example, the display control section 64 generates a screen on which the operation state of the ACC/LKA is displayed without displaying any peripheral object, as the meter screen 88 in a case in which the driving mode of the host vehicle 11 is the manual driving mode, and causes display of the meter screen 88 at the display (for example, the meter display 58).

As illustrated in FIG. 5, at the meter screen 88 in the manual driving mode, a speedometer image 90 that simulates an analog speedometer is displayed at the right side of the meter screen 88, and a tachometer image 92 that simulates an analog tachometer is displayed at the left side of the meter screen 88. Further, at an area slightly below the center of the speedometer image 90, the peripheral situation image 72 including the icon 74 representing the host vehicle 11, the boundary line 76, and the preceding object image 80 is displayed. Note that, in a case in which the driving mode is the manual driving mode, unlike the peripheral monitoring screens 70 and 86 illustrated in FIG. 3 and FIG. 4, the peripheral object image 82 is not displayed at the peripheral situation image 72 displayed at the meter screen 88. Further, at an area slightly above the center of the speedometer image 90, the icon group 84 representing operation states of the ACC and the LKA is displayed in the vicinity of the time display. In a case in which the driving mode is the manual driving mode, the icon group 84 is also displayed in the second predetermined color, thereby clearly indicating that the ACC or the like is not in operation.

In a case in which the meter screen 88 illustrated in FIG. 5 is displayed at the display, the occupant can intuitively recognize that the ACC or the like is not in operation based on the icon group 84 being displayed in the second predetermined color. Further, in a case in which the driving mode is the manual driving mode, the peripheral object image 82 is not displayed at the peripheral situation image 72 in the meter screen 88. Therefore, in a case in which the occupant feels display of the peripheral object image 82 in a state in which the peripheral monitoring screen 86 illustrated in FIG. 4 is displayed at the display as inconvenient, the inconvenience of display can be reduced by switching the screen displayed at the display to the meter screen 88 (or the travel mode display screen 94, which is described below).

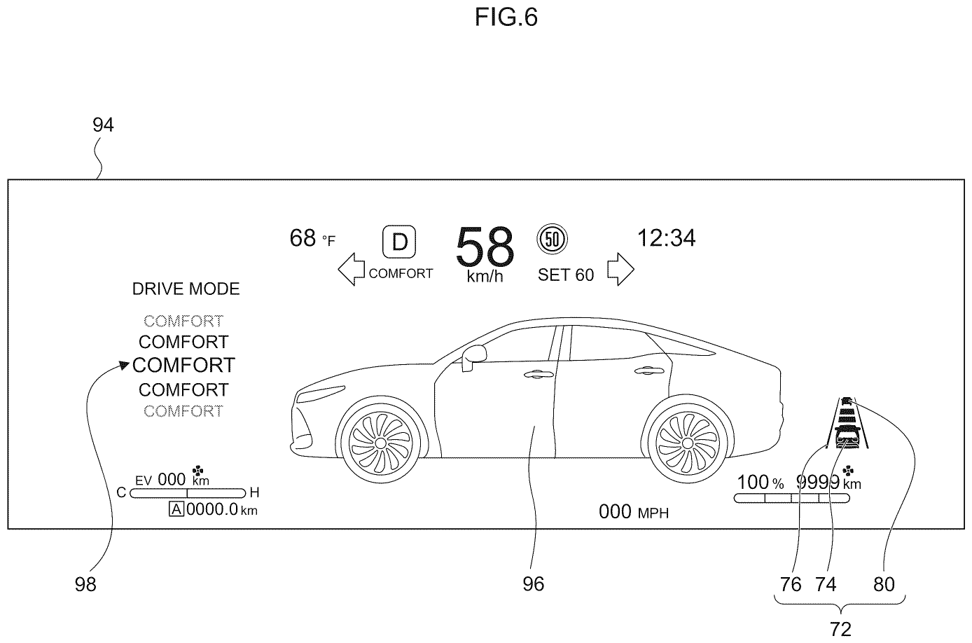

Further, in a case in which the screen that is instructed to be displayed at the display is the travel mode display screen 94, the processing transitions from step 156 to step 164. At step 164, as illustrated in FIG. 6, by way of example, the display control section 64 generates a screen on which the operation state of the ACC/LKA is displayed without displaying any peripheral object, as the travel mode display screen 94 in the manual driving mode, and causes display of the travel mode display screen 94 at the display (for example, the meter display 58).

As illustrated in FIG. 6, in the travel mode display screen 94 in the manual driving mode, a vehicle image 96 that simulates a side view of the host vehicle 11 is displayed at approximately the central portion of the travel mode display screen 94. Further, at the left side of the display position of the vehicle image 96, a current driving mode of the host vehicle 11 is displayed, and a setting image 98 that is capable of changing and setting the driving mode is also displayed. The peripheral situation image 72 including the icon 74, the boundary line 76, and the preceding object image 80 is displayed at the right side of the display position of the vehicle image 96. Note that, unlike the peripheral monitoring screens 70 and 86 illustrated in FIG. 3 and FIG. 4, the peripheral object image 82 is not displayed at the peripheral situation image 72 displayed in the travel mode display screen 94. Further, in a case in which the driving mode is the manual driving mode, the icon 74, the boundary line 76, and the preceding object image 80 are displayed in the second predetermined color, thereby clearly indicating that the ACC or the like is not in operation.

In a case in which the travel mode display screen 94 illustrated in FIG. 6 is displayed at the display, the occupant can intuitively recognize that the ACC or the like is not in operation based on the icon 74, the boundary line 76, and the preceding object image 80 being displayed in the second predetermined color. Further, in a case in which the driving mode is the manual driving mode, the peripheral object image 82 is not displayed at the peripheral situation image 72 in the travel mode display screen 94. Therefore, in a case in which the occupant feels display of the peripheral object image 82 in a state in which the peripheral monitoring screen 86 illustrated in FIG. 4 is displayed at the display as inconvenient, the inconvenience of display can be reduced by switching the screen displayed at the display to the travel mode display screen 94 (or the above-described meter screen 88).

Note that when a screen has been generated and displayed at any of steps 158, 160, 162, or 164, the screen display processing is terminated.

In this manner, in the present exemplary embodiment, in a case in which the host vehicle 11 is in the driving assistance mode, the assistance section 35 performs assistance processing that assists at least one of acceleration/deceleration of the host vehicle 11 or steering of the host vehicle 11, based on the recognition result of an object by the object recognition section 62. Further, in a case in which the host vehicle 11 is in the manual driving mode in which the assistance section 35 does not perform assistance processing, the display control section 64 causes display of the object (the preceding object image 80 and the peripheral object image 82), which is recognized by the object recognition section 62, at the display. This enables the occupant to recognize that the object has been recognized by the host vehicle 11 in a case in which the host vehicle 11 is in the manual driving mode, thereby enabling the occupant to have a sense of security.

Further, in the present exemplary embodiment, the object that is displayed at the display in a case in which the host vehicle 11 is in the manual driving mode is a peripheral object (the peripheral object image 82) that is in a lane other than the host vehicle lane in which the host vehicle 11 is traveling. This enables the occupant to recognize that a peripheral object has been recognized by the host vehicle 11 in the manual driving mode.

Furthermore, in the present exemplary embodiment, in a case in which the host vehicle 11 is in the driving assistance mode, the assistance section 35 performs assistance processing that assists at least one of acceleration/deceleration of the host vehicle 11 or steering of the host vehicle 11, based on the recognition result of an object by the object recognition section 62. In addition, in response to an input instruction, the display control section 64 switches the screen displayed at the display to the peripheral monitoring screens 70 or 86, or another screen (the meter screen 88 or the travel mode display screen 94), and in a state in which the peripheral monitoring screen 70 or 86 is displayed at the display, the display control section 64 causes display of the object that is recognized by the object recognition section 62 at the display, even in a case in the host vehicle 11 is in the manual driving mode in which the assistance section 35 does not perform assistance processing. This enables the object that is recognized by the object recognition section 62 to be displayed at the display, and enables the occupant to recognize that the object has been recognized by the host vehicle 11, simply by switching the screen that is displayed at the display to the peripheral monitoring screen 86, without performing an operation of switching to the driving assistance mode and activating the assistance processing, in a case in which the host vehicle 11 is in the manual driving mode.

Further, in the present exemplary embodiment, in a state in which another screen (the meter screen 88 or the travel mode display screen 94) is displayed at the display, the display control section 64 causes display of information including the operation state of the assistance processing at the display, but does not cause display of the object that is recognized by the object recognition section 62 at the display. This may enable the occupant to understand the operating state of the assistance processing, while enabling the complexity of display to be reduced by not displaying the object.

Note that in the above-described exemplary embodiment, explanation has been made taking ACC and LKA as examples of driving assistance functions that are realized by the assistance section 35 performing the assistance processing. However, the driving assistance functions realized by the assistance processing are not limited thereto, and may be, for example, a function that realizes hands-off driving during a traffic jam, or an automatic driving function that automatically performs both acceleration/deceleration of a vehicle and steering of a vehicle, or the like.

Further, in the above-described exemplary embodiment, explanation has been made regarding an aspect in which the display control section 64 causes display of each of the screens illustrated in FIG. 3 to FIG. 6 at the display. However, each of the screens illustrated in FIG. 3 to FIG. 6 is merely an example, and it is needless to say that each of the screens may be appropriately changed within a range not departing from the present disclosure, such as causing display of the icon group 84 instead of the peripheral situation image 72 at the travel mode display screen 94.

Furthermore, in the above-described exemplary embodiment, explanation has been made regarding an aspect in which the display control program 54 for causing the display control ECU 42 to function as the display control section 64 is stored (installed) in the storage 48 in advance. However, the display control program 54 may be provided in a form recorded in a non-transitory storage medium such as an HDD, an SSD, or a DVD.

What is claimed is:

1. A vehicle, comprising:
a plurality of memories; and
a plurality of processors coupled to the plurality of memories and to a display, the plurality of processors being configured to:
in a case in which the vehicle is in a driving assistance mode, perform assistance processing that assists at least one of acceleration/deceleration of the vehicle or steering of the vehicle, based on a recognition result of an object; and
in a case in which the vehicle is in a manual driving mode in which the assistance processing is not being performed, cause the object being recognized to be displayed at the display.

2. The vehicle according to claim 1, wherein, in a case in which the vehicle is in the manual driving mode, the object displayed at the display is a peripheral object that is in a lane other than a host vehicle lane in which the vehicle is traveling.

3. A vehicle, comprising:
a plurality of memories; and
a plurality of processors coupled to the plurality of memories and to a display, the plurality of processors are configured to:
in a case in which the vehicle is in a driving assistance mode, perform assistance processing that assists at least one of acceleration/deceleration of the vehicle or steering of the vehicle, based on a recognition result of an object;
switch a screen that is displayed at the display to a peripheral monitoring screen or another screen, in accordance with an input instruction, and
in a state in which the peripheral monitoring screen is displayed at the display, cause the object that is recognized to be displayed at the display, even in a case in which the vehicle is in a manual driving mode in which the assistance processing is not performed.

4. The vehicle according to claim 3, wherein, in a state in which the other screen is displayed at the display, the plurality of processors are configured to cause display of information including an operation state of the assistance processing at the display, and does not cause display of the object that is recognized at the display.
